(19) United States
(12) Patent Application Publication
(10) Pub. No.: US 2016/0348744 A1
(43) Pub. Date: Dec. 1, 2016

(54) METHOD FOR PRODUCING A BRAKE DISC AND BRAKE DISC

(71) Applicant: FORD GLOBAL TECHNOLOGIES, LLC, Dearborn, MI (US)

(72) Inventors: Maik Broda, Wuerselen, NRW (DE); Clemens M. Verpoort, Monheim am Rhein, NRW (DE); Ivan Jan Mathieu Ernest Bruggen, Riemst (BE); Tomasz P. Grabiec, Bergisch Gladbach, NRW (DE); Annett Bretschneider, Zwoenitz (DE); Wolfgang Kuehn, Lauter - Bernsbach (DE)

(21) Appl. No.: 15/116,742

(22) PCT Filed: Jan. 29, 2014
(86) PCT No.: PCT/EP2015/051764

§ 371 Date: Aug. 4, 2016

(30) Foreign Application Priority Data
Feb. 5, 2014 (DE) 10 2014 202 068.9

(51) Int. Cl. F16D 65/12; C23D 13/00; C09D 5/08; C03C 3/089; C03C 3/064; C03C 4/20; C23D 5/02; C03C 8/02

(52) U.S. Cl. CPC F16D 65/127; C23D 5/02; C23D 13/00; C03C 8/02; C03C 3/089; C03C 3/064; C03C 4/20; C09D 5/084; F16D 2200/003; F16D 2250/0046; C03C 2204/00; C03C 2207/08

(57) ABSTRACT

The invention relates to a method for producing a brake disc (1) for a vehicle, in which a protective layer is arranged on a base member (2) of the brake disc (1). The base member is formed of aluminum or of an aluminum alloy.

It is proposed that the method comprise at least the steps:
pre-machining at least the friction surfaces (7, 8) of the base member (2) in blank form;
applying an enamel coating (10) as an anti-corrosion and/or anti-wear layer at least onto the friction surfaces (7, 8) of the brake disc (1), and
post-treating the base member (2) coated at least in places, wherein the enamel coating (10) bonds metallurgically to the base material of the base member (2).

### CROSS-REFERENCE TO RELATED APPLICATIONS

This application is a U.S. national phase of PCT Application No. PCT/EP2015/051764, filed Jan. 29, 2015, which claims benefit of DE Application Serial No. 102014202068.9, filed Feb. 5, 2014, which is hereby incorporated by reference in their entirety.

### TECHNICAL FIELD

The present invention relates to a method for producing a brake disc for a vehicle, and to a brake disc for a vehicle.

### BACKGROUND

DE 1 625 680 concerns a friction member for wet clutches and brakes having a support and at least one sintered, porous and metallic friction lining applied on the support. It was proposed that the friction lining consist of metal fibers, wherein the degree of porosity should amount to at least 50%. Once the friction lining of sintered metal fibers has been fixedly applied, an enamel frit is applied onto the friction surfaces in the form of a slurry.

U.S. Pat. No. 6,032,769 concerns a brake disc which comprises a base member with ribs. Friction rings are mounted on a core, which may consist of gray cast iron, by being fastened to support ribs. An adhesive is arranged between the ribs and the friction rings to secure the connection further, wherein enamel is also mentioned as an adhesive. The adhesive is also intended to be a noise-reducing element.

The publications RAL, Deutsches Institut für Gütesicherung und Kennzeichnung e.V. [German Institute for Quality Assurance and Certification], 2007; PETZOLD, Armin; PÖSCHMANN, Helmut, Email und Emailliertechnik [enamel and enamel technology], Deutscher Verlag für Grundstoffindustrie, 1992 and Dietzel, Adolf H.; Emaillierung [enameling], Berlin, Springerverlag 1981, page 1 and 2; pages 38 to 42 and page 276 disclose enamels, the constituents and production thereof and also enameling methods.

DE 43 21 713 A1 discloses an assembled disc brake rotor and a method for the production thereof. The disc brake rotor may be cast from an aluminum matrix composite material with a proportion of 20 to 30 wt. % silicon carbide. The annular wall surfaces thereof are mechanically roughened, such that a coating can adhere better to the annular wall surface. The coating is applied thermally, wherein thermal spraying methods, such as for example by means of arc plasma or by means of an electrical arc, are proposed. Application by means of combustion flame or by means of detonation gun is also stated to be possible. Coating may proceed in two steps, wherein an intermediate coating may be applied between the annular wall surface and an outer coating. Suitable materials for the outer coating are stated to be simulated cast iron, wherein by way of example nickel in combination with graphite or for example an aluminum/cast iron composite material is disclosed as intermediate coating material.

DE 1 285 692 A discloses a base enamel which consists of one or more fused frits with an SiO₂ content of at least 60% and a boron-containing mill additive. The mill additive contains 5 to 50 borax relative to the fused frits.

It is known from DE 10 2010 049 797 A1 that a brake disc can be produced integrally with a wheel hub, it being intended that brake disc wobble can be reduced thereby. The friction surfaces of the brake disc could additionally be provided with a friction coating which can consist of hard metal or a ceramic.

EP 1 987 267 B1 concerns a brake disc which involves the use of materials, one of which is intended to perform a structural function and the other a braking function. The brake disc comprises a support or structural disc, the sides of which are equipped with a first and a second friction disc. The friction discs are produced from a suitable material for performing the braking function. The structural disc is produced from composite material. The composite material of the structural disc may consist of a resin selected from epoxy, phenolic, cyanate ester, cyanepoxy, ceramic resins and enamel or a combination of these. The friction discs may be produced from a material selected from steel, cast iron, hardened aluminum, alumina (ceramic), silicon carbide, silicon nitride, titanium carbide and carbon ceramic.

In vehicles, in particular in motor vehicles, disc brakes are probably the most widespread design of brake systems. Disc brakes are substantially made up of a brake disc and a brake caliper which grips the periphery of the brake disc. The brake disc is here connected via a wheel hub rotatably mounted in the steering knuckle to the vehicle wheel to be braked. The brake caliper, on the other hand, is fixed to the steering knuckle. The actual deceleration is achieved by brake pads which can be applied against the brake disc and are arranged on both sides of the brake disc between the disc and the brake caliper.

Depending on the field of application, brake discs may consist not only of iron, for example of gray cast iron (GG), but also of carbon ceramics or aluminum. Brake discs should here have a surface which, as far as possible, is wear-resistant and releases little fine dust. The hardest possible surface is desired in order to achieve this. For example in the case of aluminum brake discs, silicon carbide (SiC) is accordingly added which precipitates out as a wear-resistant protective layer on the surface. Producing brake discs from non-ferrous materials is, however, sometimes difficult and usually costly.

Today's brake discs thus predominantly consist of gray cast iron material. Replacing the heavy gray cast iron material with light metals, thus preferably with aluminum materials, can achieve mass savings, for example in an unventilated 16″ disc, of approximately 1.9 kg per brake disc. In addition to the weight reduction of the overall vehicle, further advantages with regard to driving dynamics are achieved where weight savings are made in unsprung masses. The problem with Al discs, however, is that the Al material on the one hand has a low melting point and on the other hand does not have sufficient wear resistance or suitable coefficients of friction to be a tribologically suitable functional surface for brake discs.

Efforts have accordingly been made (see above) to achieve a highly wear-resistant friction surface on aluminum brake discs by adding particulate reinforcing material as an alloy component. To this end, however, after mechanical pre-machining, the surfaces have to be roughened by etching in sodium hydroxide solution to such an extent that the friction surface forms a functional tribological system with the friction lining counterpart and, after a technically expedient time, can transfer sufficient friction power by forming a “transfer film”. Such Al alloys may be produced either by casting a prealloyed Al material (Duralcan®) or by powder metallurgical production (PEAK spray compaction with 20-40% SiC). The disadvantage of such solutions, however, resides in the low ductility of such alloy systems and in the high costs of post-machining the components by diamond grinding.

Thermal spraying is another way of forming such a protective layer. In this case, the material to be applied onto the surface of a base member of the brake disc is presoftened under the action of heat and accelerated in the form of individual particles by means of a gas stream. On impact of the particles, a purely mechanical bond is formed without the surface of the base member being melted. The materials may be metals and oxide ceramic or carbide materials.

DE 10 2005 008 569 A1, for example, describes that a self-fluxing nickel-based powder alloy is applied onto the brake disc by thermal spraying, since in this manner a certain basic adhesion would already be present before melting. After adjusting the brake disc to size, i.e. before thermal coating, the areas to be coated would merely be sand-blasted in order to increase surface roughness, so meaning that good conditions would appear to be achievable for good adhesion of the sprayed layer. DE 10 2009 003 161 A1 discloses that a light metal brake disc has a thermally sprayed layer applied by means of PTWA (plasma transfer wire arc). The sprayed layer, i.e. the thermally insulating friction layer, is formed from a metal alloy comprising nanocrystals.

Electrodeposited Ni plus SiC reinforcing layers are furthermore known from the literature. These layers are very complex to produce. In the electrodeposition method, the entire component must be coated for example with chromium or nickel or Ni plus hard material particles. Not only electrodeposited coatings of this kind but also thermally sprayed coatings perform rather poorly in salt spray testing: for instance, creepage under thermally sprayed layers cannot reliably be prevented even with additional sealing methods.

Abrasion between the brake lining and brake disc gives rise to particulate emissions, i.e. fine dust. In addition to the fine dust problem, however, the visual effect of rusted brake discs in combination with costly aluminum wheel rims is also of significance. It is known that approximately 70% of the fine dust particles originate from the gray cast iron disc material. These wear particles, which also originate from the brake pads, have a very high temperature of up to 700° C. when they come into contact with the aluminum wheel rim. In so doing, they can easily burn into the clear coat on the aluminum surface and removing the gray-black deposit is very difficult even in a washing installation and with application of considerable effort. Squealing or rubbing when brake linings are rusted tight after an extended standstill are additionally considered troublesome.

Neither the electrodeposited coating nor the thermally sprayed coating permit the production of friction linings which combine long-term corrosion resistance with sufficient wear resistance and an optimum coefficient of friction. Due to these shortcomings of the known methods, there is a requirement for a suitable coating which not only meets all the requirements for reliable functioning of the component with minimum manufacturing costs, but may at the same time also be integrated into the manufacturing chain in the production of Al brake discs.

In the light of the stated problems, there is still room for improvement in the simple and sustainable manufacture of brake discs, in particular of aluminum brake discs, as mass-produced items.

Against this background, the problem addressed by the invention is that of providing a method for producing a brake disc for a vehicle which permits inexpensive and nevertheless sustainable mass production. The intention is furthermore to state a vehicle brake disc which, in addition to being inexpensive to manufacture, in particular has improved resistance to corrosive attack and an improved service life.

### SUMMARY

A method for producing an aluminum brake disc with a protective enamel layer metallurgically bonded to a roughened surface of the disc. The enamel layer forms a friction coating comprising the following constituents by weight:

| Oxide | Proportion by weight |
|---|---|
| SiO₂ | 5-50% |
| BaO | 2-20% |
| B₂O₃ | 0.5-10% |
| Li₂O | 0.5-15% |
| K₂O | 5-30% |
| Na₂O | 5-44% |
| Sb₂O₃ | 0.5-25% |
| TiO₂ | 2-40% |

### BRIEF DESCRIPTION OF THE DRAWINGS

Further advantageous details and effects of the invention are explained hereinafter in greater detail on the basis of various exemplary embodiments illustrated in the figures, in which:

FIG. 1 is a schematic diagram of a brake disc according to the invention in plan view,

FIG. 2 shows the brake disc from FIG. 1 in sectional view,

FIG. 3 is a detail from FIG. 2, and

FIG. 4 shows a ventilated brake disc, partially cut away, in perspective view.

Identical parts are always provided in the various figures with the same reference numerals, such that they are as a rule described only once.

### DETAILED DESCRIPTION OF THE PREFERRED EMBODIMENTS

It should be noted that the features and measures listed individually in the following description may be combined in any desired, technically expedient manner and disclose further configurations of the invention. The description additionally characterizes and gives details of the invention in particular in connection with the figures.

The invention proposes a method for producing a brake disc for a vehicle, in which a protective layer is arranged at least in places on a base member of the brake disc. The base member is formed of aluminum or of an aluminum alloy. According to the invention, the method comprises at least the following steps:
pre-machining at least the friction surfaces of the base member in blank form;
applying an enamel coating as an anti-corrosion and/or anti-wear layer at least onto the friction surfaces of the base member, and
post-treating the base member coated at least in places, wherein the enamel coating bonds metallurgically to the base material of the base member.

The enamel coating according to the invention is preferably a melt mixture. At enameling temperature, the glass-forming oxides melt together to form a glass melt. Glass-forming oxides may here be SiO₂, B₂O₃, Na₂O, K₂O and Al₂O₃. Base enamels comprise borax, feldspar, quartz and fluoride, with the remainder being soda and sodium nitrate. Oxides of Ti, Zr and Mo can serve as opacifiers.

In order to achieve higher mechanical strength, a specific proportion of alkaline earth metal aluminates is added to the enamel coating. The proportion of alkaline earth metal aluminate may amount to between 3 and 35% relative to the weighed amount of enamel frit. A molar proportion of rare earths may also be added to the alkaline earth metal aluminate to further increase strength. The alkaline earth metal aluminate is preferably added in the form of Portland cement (alkaline earth metal silicon aluminate). It is important to select a very fine grind in order to achieve a high strength. On combination with water (H₂O), calcium silicate hydrates are formed as fine acicular crystals which interlock with one another and thus result in high strength.

In a preferred development, the stated substances are finely ground and melted. The melt is quenched, i.e. preferably introduced into water, wherein the resultant granular vitreous frit (enamel frit) is again finely ground in the following step. During grinding, for example 30% to 40% of water together with clay and silica flour are added. Depending on the type of enamel, the mentioned opacifiers and coloring oxides are also added.

In this manner, an enamel slip is formed which should preferably stand for some time, preferably for some days, to improve mixing before the enamel slip is put to further use. Using suitable floating agents ensures that a uniform layer thickness is obtained, for example after dip coating, wherein further details are provided below regarding possible dip coating.

As has already been mentioned, the base material provided for the brake disc, i.e. for the base member, is aluminum or an aluminum alloy.

The brake disc, i.e. the base member thereof, may be produced, for example for unventilated brake discs, by deep drawing/forging from a wrought alloy, for example Al6061. It is also possible to produce the brake disc by casting methods, for example low pressure die or sand casting or using the HPDC process (High Pressure Die Casting). Various casting methods are thus also suitable for producing the brake discs for the subsequent surface coating process and the required high baking temperature. When using the HPDC process, however, a particularly good vacuum should be used in order to prevent the formation of bubbles (blistering problem) during the necessary baking operation (see further below).

The base member, i.e. the blank, here comprises a peripheral outer brake ring which is provided for contact with a brake pad of a brake caliper, wherein the brake pads or brake linings naturally grip both sides of the brake ring, i.e. the friction surfaces. In the center of the base member there is an opening which is arranged in a protrusion of the base member. Around the opening there are preferably arranged five uniformly spaced through-holes extending through the protrusion. Said through-holes serve to receive wheel nuts by means of which the brake disc may be joined together with a wheel to a wheel hub. The protrusion, which may also be designated disc boss, may be produced integrally with the brake ring, i.e. also cast, or be suitably joined to the brake ring as a separate element. The base member may, as is known per se, be produced as an unventilated or ventilated brake disc. In the case of a ventilated brake disc, the friction surfaces are arranged on outer discs, wherein the opposing outer discs are spaced apart by ribs. As is known per se, each outer disc of course also only has one friction surface. In this manner, an air gap is formed between the outer discs, as is likewise known per se, for which reason no further details will be stated in this respect.

This blank is then pre-machined at least in places, wherein according to the invention at least the future friction surfaces are pre-machined. Pre-machining may proceed by means of mechanical methods, wherein pre-machining is preferably carried out by means of turning methods, more preferably by means of dry turning methods. The regions to be coated, i.e. for example the friction surfaces, are preferably machined such that they have a roughness of for example 5 to 15 μm. Pre-machining may also be carried out by sand-blasting, wherein still further suitable pre-machining methods should not be ruled out. In principle, pre-machining may thus proceed by rough turning or by turning with additional corundum blasting.

Once at least the friction surfaces have been pre-machined, the enamel coating can be applied. This may thus proceed by means of spraying, wherein however application by brushing or in a dip bath may also be expedient. In this respect, it is convenient for the coating, i.e. the enamel slip, to be applied as a wet enamel coating.

In the case of spraying, it is expediently provided that the enamel coating is applied as an aqueous suspension (enamel slip). It is advantageous for at least the pre-machined region to be very easily accessible, since the spraying device can then individually cover the region to be coated. The coating may be applied in such a manner that the base member preferably rotates. It is possible to cause the brake disc to rotate at 60 to 120 rpm. The enamel coating can be sprayed by atomization under a pressure of for example 2 to 4 bar. The enamel coating may accordingly be applied to the desired material thickness within a very short time of for example 20 seconds, wherein the delivery rate of the enamel slip is controllable within tight limits by automatic monitoring of parameters, for example by means of computer-controlled spraying robots, in order to be able to produce the respective enamel coating with in each case slight fluctuations in thickness. A single-stage enamel coating operation may be selected in the method according to the invention. In this respect, it is possible to dispense with separate application of base enamel and top coat enamel, since only single-stage application is preferred. It is also possible initially to apply a thinner slip layer and to dry it, wherein said operation may be carried out repeatedly in order to apply the desired layer thickness. A rotating spraying device with a stationary disc brake to be coated is also possible. In this respect, merely the region of the friction surfaces may be provided with the enamel coating. This may be the case not only with unventilated but also with ventilated brake discs. In a further possible development, the base member may be coated in a dip bath, wherein an aqueous solution (enamel slip) is likewise provided. In this case too, merely the brake ring, i.e. merely the friction surfaces, may be coated. The base member is here not completely immersed in the dip bath, but instead merely sufficiently deep for the brake ring to be immersed in places. The entire brake ring is coated in this manner by rotating the brake disc. A ventilated brake disc is in particular expediently provided with the enamel coating by means of the dip bath, since the wet enamel coating can also pass completely into the interspace between the two outer discs, such that the inner surfaces on the opposite side to the friction surfaces may be coated, wherein the ribs may of course likewise be coated. Coating the interspace leads to the convenient result of complete corrosion protection, whereby the service life of the brake disc is clearly extended, wherein the additional wear protection on the friction surfaces of course likewise contributes to the extension in service life due to the enamel coating located there.

Instead of coating only in places, in which only the brake ring, i.e. the friction surfaces, is/are coated, the base member may also be completely coated. In this case, the brake disc is then completely protected against corrosion. It is conveniently then provided that the base member is also completely pre-machined. Pre-machining in the interspace between the two outer discs may be provided, if it can be expediently carried out.

Enamel coating may again be provided by means of a spraying device or in a dip bath. The brake disc is completely immersed in the dip bath if the brake disc is to be completely coated. Rotation thereof is not necessary, but may be desirable. If the enamel coating is applied by means of the spraying device, enamel coatings which differ at least with regard to their perceived color may be applied. The protrusion, i.e. the disc boss, could for example also be made brightly luminous in low light. This is expedient because the protrusion itself is not exposed to any friction forces like the friction surfaces are. The friction surfaces could of course nevertheless also be provided with a specific perceived color if it were ensured that the perceived color remained unchanged after attack by the brake linings, i.e. after wear on the respective friction surfaces.

If the brake disc is coated at least in places, it is post-treated in a further step. It is advantageously provided to this end that the enamel coating is firstly dried after application, wherein a baking treatment is then provided. The enamel coating is dried by introducing the brake disc into a drying device, wherein the enamel-coated brake disc is dried at around 60 to 80° C., also at around 80 to 120° C., for a duration of 5 to 30 min. In one possible development of the method, the drying operation is carried out in a circulating air oven. For the subsequent heat treatment, the enamel-coated brake disc is baked, i.e. fused, in a tunnel oven at around 550° C., for example in a tunnel oven. In this way, the enamel coating can bond metallurgically with the base material of the base member. The bond between the enamel coating and the aluminum surface is created by the formation of interlocking regions which for example arise from the dissolution of Al₂O₃ at the reaction boundary between the aluminum and the enamel coating. Si⁴⁺ here diffuses into the aluminum surface, where it is reduced to Si. Moreover, alkaline attack of the aluminum surface by the alkalis in the enamel slip also promotes adhesion. This stoving operation results in the formation of a dense, continuous oxide layer which is highly resistant to the corrosive attack of rainwater and in particular also of salt water. In this respect, the first function of the enamel coating as an anti-corrosion coating is achieved.

Enamel coatings according to the invention are distinguished from electrodeposited or sprayed coatings in that they are not subject to creepage. If creepage occurs under protective layers, an Al oxide phase forms under the coating which then leads to a major increase in volume associated with spalling of the top coat. It is also convenient that enamel coatings according to the invention also then suffer no further damage if, due to local damage (stone impact, mechanical degradation) the layer is removed down to the base material. Corrosive damage will then only occur in the region of the missing enamel coating, but will not extend any further. A further advantage of the enamel coating according to the invention may be considered that said coating is very light in weight thanks to the chemical composition of the aluminum oxides, silicates etc. and to the pores and bubble structure typical of enamel.

In addition to having this good corrosion resistance, the enamel coating according to the invention is distinguished by good wear resistance due to the high layer hardness of 600 to 800 HV0.1, which may thus be up to four times the hardness of the aluminum base material. In this respect, the enamel coating has a second function as an anti-wear layer, wherein the enamel coating virtually forms the friction partner of brake disc for the brake pads, i.e. for the friction linings thereof. Resistance to wear and/or thermal cracking can be further increased by using “partially crystalline enamels”, in which crystallizing precipitates in the glass matrix increase wear resistance in comparison with conventional enamels. It is also convenient that the wear behavior of the enamel can be dramatically improved by the inclusion of nanoscale hard materials. These carbide hard materials have distinctly higher resistance to wear than the amorphous enamel matrix. Wear resistance may be further optimized by varying the size of the carbide particles.

As has already been stated above, aluminum or an aluminum alloy may be used as base material. Previously and hereafter, aluminum is mentioned, wherein aluminum should also be taken to include an aluminum alloy.

After the stoving step, the enamel coating surface may be subjected to a final treatment, i.e. provided with a finish. It is preferably provided to turn the friction surfaces and to remove the oxide layer which has arisen due to the baking process.

The brake discs may of course also be used without any machining in the region of the friction surface. Possible runout and also roughness can be minimized by using thinner enamel layers for sintering the layers with rotational movement. It is also possible to post-machine the discs by post-grinding, wherein diamond or hard material cup wheels are used. It is also conceivable to carry out post-machining by turning, which is feasible despite the brittleness due to high hardness, wherein PCD (polycrystalline diamond) reversible cutting tips are preferred. After finish machining, at least in the attack region of the friction linings, i.e. brake linings, the enamel coating may have roughness values of Ra: 0.02 to 0.05 μm and Rz: 0.09 to 0.26 μm, wherein the values should of course be taken only to have been stated by way of example.

It is convenient for an enamel coating to be applied with a layer thickness of 50 μm to 1000 μm. In this way, it is possible to produce brake discs which could have a service life exceeding 240,000 km, depending on the layer thickness of the enamel coating.

In order to ensure sufficiently high wear resistance, it has proven expedient to adjust the composition of the enamel coating in such a manner that, after sintering, i.e. after the baking operation, hardness values of for example 650 HV0.1 are obtained. Moreover, this composition does not give rise to a completely fused vitreous enamel coating with the smooth surfaces typical of enamel, but instead to a somewhat rough surface caused by the higher content of crystalline phases. The crystal content may ideally amount to 20%, or indeed 30-50%.

Thanks to the excellent resistance to corrosion and wear of the friction layer, the enameling method according to the invention is particularly suitable for the production of aluminum brake discs. The method according to the invention furthermore provides the possibility of adjusting the coefficients of friction within broad limits by adding specific oxides in such a manner that conventional friction linings can be used, wherein both corrosion resistance and wear resistance are considerably improved in comparison with conventional gray cast iron brake discs.

The enamel coating may additionally be colored, whereby various colors may be individually selected, as has already been mentioned above, wherein the enamel coating also shows the color once attrition has already occurred. This fortunately gives rise to a safety feature which will be addressed below.

With the invention, an enamel coating can be applied as corrosion protection onto the entire brake disc, wherein the enamel coating may also only be applied in the region of the friction surface as a wear lining with an adapted coefficient of friction (avoidance of grind noise), such that the enamel coating serves as friction partner for the brake linings. The enamel coating may be applied as a fluorescent, decorative, easily cleaned lining in the region away from the friction lining contact surface, wherein the enamel coating may be applied in the contact region (disc boss, cup) in order to facilitate removal of the brake disc (prevention of jamming on the wheel hub). In principle, the enamel coating is also more advantageous in this region than other layer or coating systems, since the dense, continuous enamel coating can be more easily cleaned, also because any hot dust particles from the brake lining cannot so readily burn into the enamel coating. The method according to the invention may comprise the steps pre-machining, application of the slip by dipping/spraying, drying and sintering and finishing to achieve a desired roughness. The enamel coating may additionally have a thermally insulating action, such that the heat generated would not be so quickly dissipated.

Although a single-stage coating method is preferred, it is possible to dip the brake disc completely in an inexpensive enamel slip, which is in particular convenient in ventilated discs having many connecting pieces between the two outer discs, wherein a high quality, colored enamel layer is then applied in a following spray application in the region between friction lining surface and cup contact surface (disc boss), i.e. in the brake lining attack region. In this respect, it is possible to apply an enamel coating in the region of the brake disc not subject to abrasive wear which is inexpensive and not so wear-resistant, but should be adapted such that it has the same temperature range for sintering as the enamel coating which is applied in the abrasive region. A grind noise problem due to the brake lining becoming baked on, as may occur in conventional gray cast iron brake discs, is in principle avoided with the enamel coating. If the enamel layer is colored, it may additionally be used to indicate for example a shortly upcoming, necessary replacement of the brake disc. Once the colored enamel layer on the braking surface has been eroded after a certain time, i.e. for example when the base material with its typical appearance is visible, this may be used as an indicator that the brake disc must soon be replaced. For example, if the silvery sheen of the aluminum shines through the colored enamel coating, even an inexpert user can easily tell that the brake disc should be replaced. In this respect, another safety feature is fortunately created.

The edges of the base member coated with an enamel coating preferably have a radius R which is at least three times greater than the layer thickness of the enamel coating in the region of the edge radius. In this way, a uniform layer thickness is ensured in the edge region. Excessively sharp transitions or edges may result in the enamel layer formed there being too thin.

The invention thus provides applying an enamel coating at least onto the friction surfaces of the brake disc and using this enamel coating at least as a friction partner for the brake linings. It is accordingly inter alia possible to avoid the hot fine dust which would otherwise occur and burn into light metal wheel rims if the light metal brake disc were for example coated by means of simulated cast iron. It is convenient for the purposes of the invention that the resultant brake disc produced using the enamel coating as anti-corrosion and anti-wear layer has a substantially longer service life than conventional brake discs or brake discs which have a coating applied for example by means of a thermal spraying method, for example with self-fluxing powder alloys.

The enamel coating may also be made such that the coating is illuminated by input of heat, wherein enamel coatings are conceivable which emit light without prior exposure to light. The entire brake disc may in principle have a fluorescent enamel coating, so resulting in a further safety feature for night driving. It is also possible to make the aluminum brake disc thinner using the inventive procedure in comparison with known procedures, wherein said disc may for example be 1.75 mm thinner, since the hard enamel coating exhibits virtually no wear on the friction surface (if particularly high quality enamel coatings are selected). The brake disc is furthermore advantageously provided with an enamel coating, i.e. weight-optimized, since the enamel coating consists of light oxides with a specific weight of 1.2 to 2.0 g/cm³, such that the enamel coating is virtually half the weight of a comparable layer of aluminum, wherein the enamel coating has very much higher wear resistance.

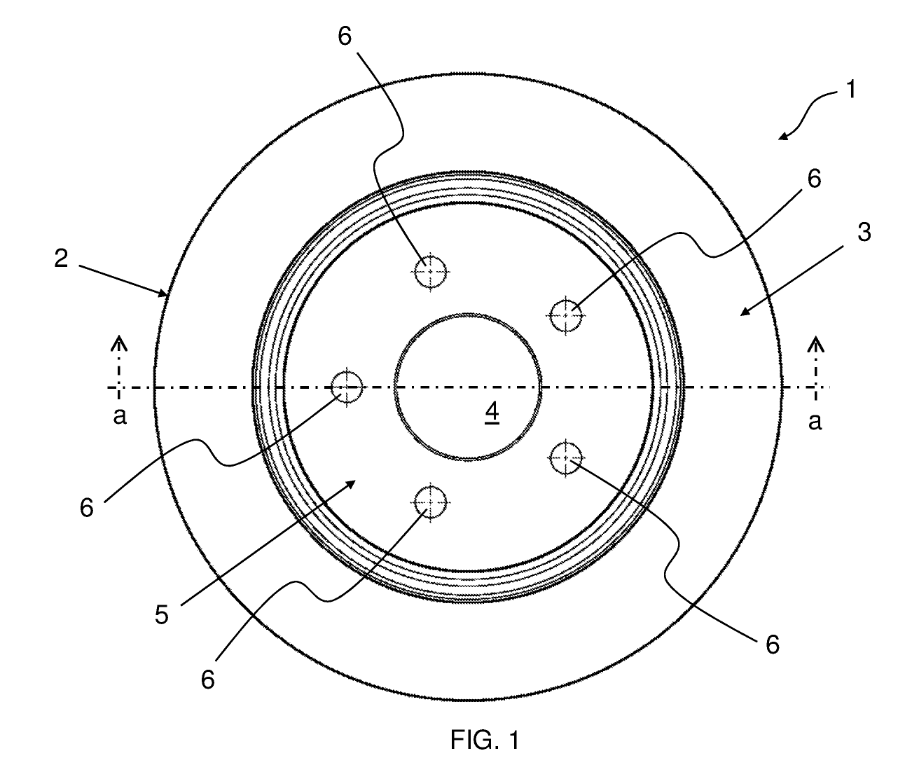

FIG. 1 is a schematic diagram of a brake disc 1 according to the invention. Brake disc 1 has a circular base member 2, by way of example of aluminum, i.e. for example Al6061. The base member 2 typically has a peripheral outer brake ring 3 which is intended for contact with a brake lining (not shown). In the center of the base member 2 there is an opening 4, which is arranged in a protrusion 5 of the base member 2. The protrusion 5 may also be designated disc boss 5. Around the opening 4, there are arranged in the present case five uniformly spaced through-holes 6 extending through the protrusion 5. Said through-holes 6 serve to receive wheel nuts, not shown here in greater detail, by means of which the brake disc 1 may be joined together with a wheel, not shown, to a wheel hub, likewise not shown.

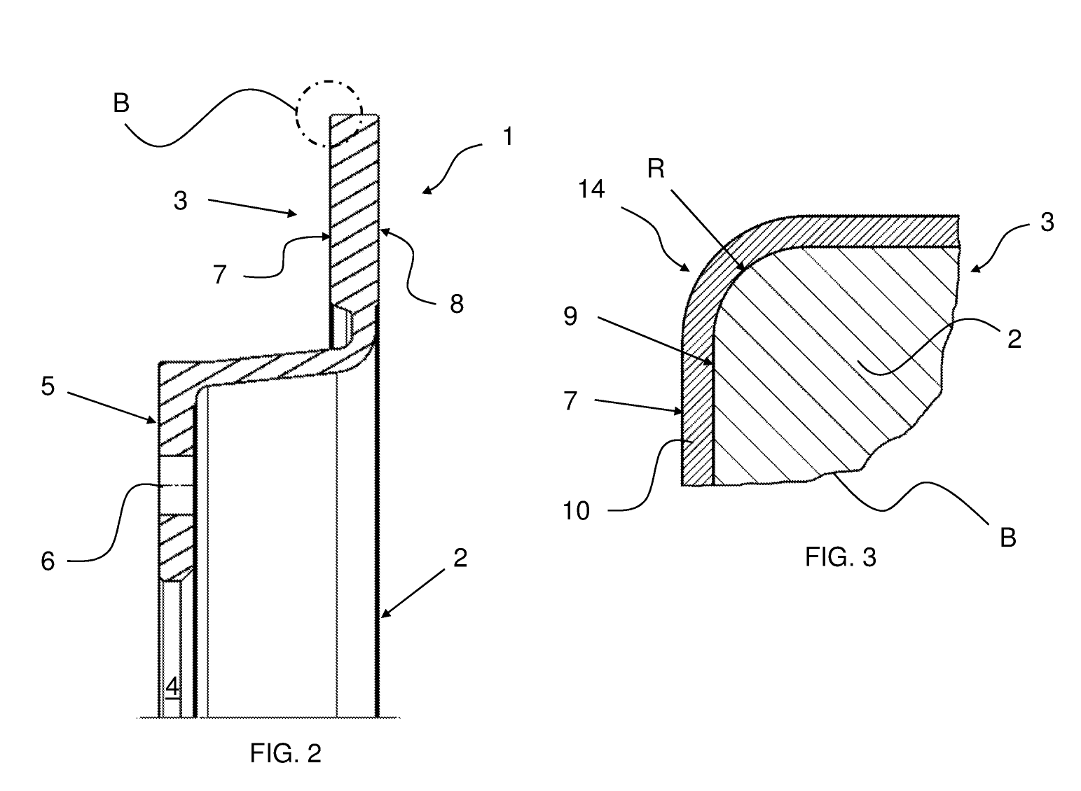

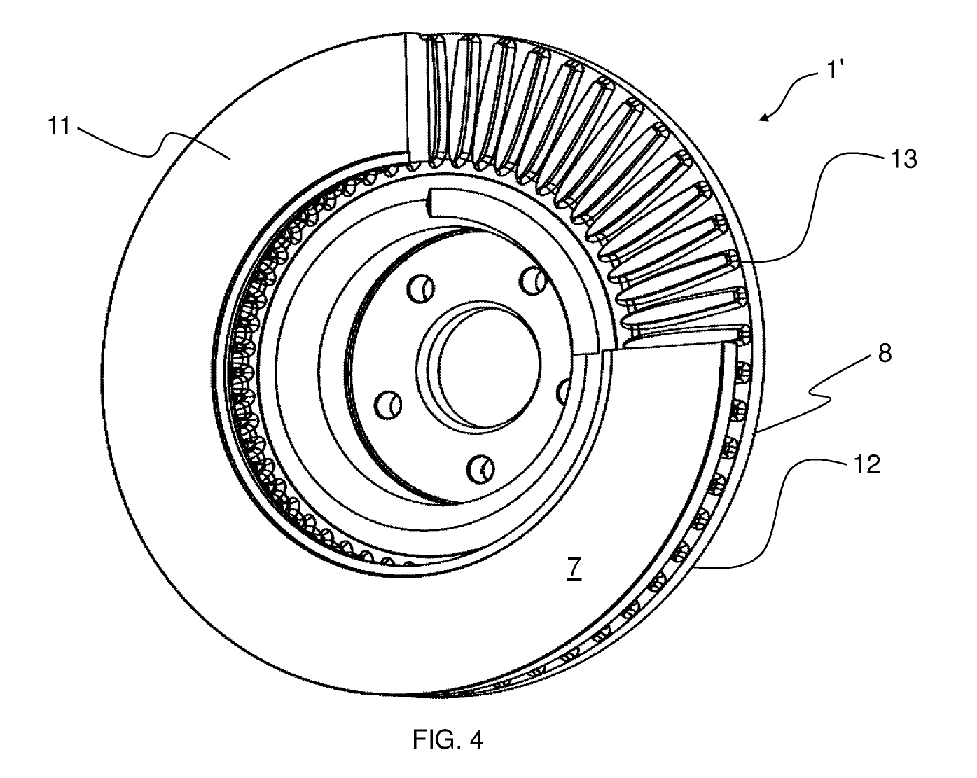

FIG. 2 shows an enlarged section through the plane a-a of brake disc 1 from FIG. 1. As is apparent, the protrusion 5 projects out relative to the brake ring 3 of the base member 2. The brake ring 3 comprises two brake surfaces oriented parallel to one another, i.e. friction surfaces 7, 8, i.e. a first friction surface 7 and a second friction surface 8. A dash-dotted circle B is drawn on FIG. 2, wherein the region of the brake ring 3 within the circle B is the content of FIG. 3.

FIG. 3 shows a detail of the brake ring 3 from FIG. 2 within the circle B. It is apparent from the enlargement of the brake ring 3 in the region of the first friction surface 7 thereof that an enamel coating 10 is applied in this region on a surface 9 of the base member 2. The enamel coating 10 here also covers the outer circumferential surface. In this respect, the entire brake disc 1 may have an enamel coating 10. It is, however, also conceivable for only the friction surfaces 7 and 8 to have the enamel coating 10. The enamel coating 10 has a twin function. The enamel coating 10 firstly provides corrosion protection of the brake disc 1. Secondly, the enamel coating 10 simultaneously functions as the friction layer of the brake disc 1.

The edge 14 is made with a radius R such that a uniform enamel layer is applied in this region. The radius R is here roughly three times the layer thickness of the enamel coating 10. Larger radii are unproblematic, while with smaller radii, the layer thickness may be unevenly distributed in the region of the edge 14.

The enamel coating 10 may also be applied at least in places on the brake disc, wherein only the friction surfaces 7 and 8 are provided with the enamel coating 10. It is, however, also possible, as mentioned, to provide the brake disc 1 completely with the enamel coating. The enamel coating may be applied by means of spraying devices or in a dip bath.

FIG. 4 shows a partial cut away of brake disc 1′ which has outer discs 11 and 12, between which are arranged ribs 13, such that a ventilated brake disc 1, is formed. The ventilated brake disc may also have the enamel coating 10 only on the friction surfaces 7 and 8 thereof. It is favorable, however, for the ventilated brake disc to be completely coated with enamel. To this end, the ventilated brake disc may be placed in a dip bath, such that also the inner surface of the mutually opposing outer discs 11 and 12 and the ribs 13 are coated with enamel.

It is also possible for the brake disc 1′, to have different enamel coatings. It is accordingly preferred to select a coating for the friction surfaces 7 and 8 which has the stated twin function with the necessary coefficients of friction, such that the function of the brake disc 1′, is maintained. On the surfaces away from those required for decelerating the vehicle, the brake disc may have an enamel coating which has a further function, for example in the form of signaling effects, such that said coating is also brightly luminous in darkness. It is entirely within the purposes of the invention also to provide friction surfaces with such a signaling enamel coating.

In any event, the brake disc should be pre-machined at least in places prior to application of the enamel coating 10. It is favorable to machine the region of the brake disc 1 which is also to be coated.

Once the enamel coating 10 has been applied, drying and a baking treatment are provided. Mechanical post-machining may optionally also be performed.

### LIST OF REFERENCE SIGNS

1, 1′ Brake disc
2 Base member
3 Brake ring
4 Opening
5 Protrusion/disc boss
6 Through-hole
7 First braking surface/friction surface
8 Second braking surface/friction surface
9 Surface
10 Enamel coating
11 Outer disc
12 Outer disc
13 Ribs
14 Edge
R Radius

What is claimed:

1. A method for producing an aluminum or aluminum alloy brake disc having an anti-corrosion and anti-wear enamel coating on at least one friction
comprising:
pre-machining the friction surfaces (7, 8);
applying the enamel coating (10) onto the friction surfaces (7, 8); and
post-treating the brake disc at least in places, wherein the enamel coating (10) bonds metallurgically to the brake disc.

2. The method of claim 1, wherein
the enamel coating (10) is a melt mixture which comprises glass-forming oxides together with borax, feldspar, quartz, fluoride, soda, sodium nitrate and opacifiers.

3. The method of claim 2, wherein
the enamel coating (10) comprises oxides of cobalt, manganese and nickel.

4. The method of claim 2, wherein
the enamel coating (10) has a hardness which is a multiple of that of the aluminum or of an aluminum alloy brake disc.

5. The method of claim 1, wherein
the pre-machining step is carried out by means of a turning method.

6. The method of claim 5, wherein
the pre-machining step creates for a surface to have a roughness Rz of 5 to 15 μm.

7. The method of claim 1, wherein
the enamel coating (10) is applied by spraying.

8. The method of claim 1, wherein
the enamel coating (10) is applied in a dip bath.

9. The method of claim 1, wherein
the applied enamel coating (10) is dried, wherein the brake disc (1) is subsequently subjected to a baking treatment.

10. The method of claim 1, wherein
the applied enamel coating (10) is subjected to mechanical post-machining.

11. A brake disc for a vehicle comprising; aluminum containing friction surfaces (7, 8), having a protective enamel coating resistant to wear and corrosion.

12. The brake disc of claim 11, wherein
the enamel coating (10) is arranged completely on an aluminum base member (2).

13. The brake disc of claim 11, wherein
the enamel coating (10) has a thickness of between 50 and 1000 μm.

14. The brake disc of claim 13, wherein
edges of the base member (2) have a radius R which is at least three times greater than the layer thickness of the enamel coating (10) in the region of the edge radius.

15. A brake disc made by the following process:
pre-maching friction surfaces of the brake disc;
applying an enamel coating to the pre-machined friction surfaces; and
post-treating the brake disc to metallurgically bond the enamel to the pre-machined friction surfaces.

16. An enamel coating for an aluminum brake disc comprising:
SiO₂ 5-50%;
BaO 2-20%;
B₂O₃ 0.5-10%;
Li₂O 0.5-15%;
K₂O 5-30%;
Na₂O 5-44%;
Sb₂O₃ 0.5-25%; and
TiO₂ 2-40%.
